(19) United States
(12) Patent Application Publication
(10) Pub. No.: US 2026/0037932 A1
(43) Pub. Date: Feb. 5, 2026

(54) METHODS TO IMPROVE EXPERIENCE IN SHARING LINK POSTS

(71) Applicant: Adeia Guides Inc., San Jose, CA (US)

(72) Inventors: Tao Chen, Palo Alto, CA (US); Ning Xu, Irvine, CA (US)

(21) Appl. No.: 18/791,001

(22) Filed: Jul. 31, 2024

(51) Int. Cl. G06Q 50/00; G06F 16/9538

(52) U.S. Cl. CPC G06Q 50/01; G06F 16/9538

(57) ABSTRACT

Methods and systems are disclosed herein for sharing content through links via social media networks. A system accesses a link post on a social networking service with a link to access shared content via a network. The system determines that a device associated with a user account has limited access to the shared content. Based at least in part on determining that the device associated with the user account has limited access to the shared content, the system identifies alternative content and provides the alternative content for consumption via the device associated with the user account.

### BACKGROUND

The present disclosure relates to sharing content, and more particularly to systems and methods and related processes for sharing content through links via social media networks.

### SUMMARY

On many social networking services, social media posts can contain a clickable preview card of a shared link to, e.g., a webpage, video, article, and/or other content within or outside of the social media network. Shared link posts are a popular way of distributing, promoting, and sharing content. Millions of posts each day on, e.g., Facebook, X (formerly known as Twitter), LinkedIn, Instagram, TikTok, and other services include links for content on which they are commenting and/or sharing. With a shared link post, a link preview card may be automatically generated by the social networking service, using the metadata that the linked content provides. The content of a shared link often has controlled access, e.g., through subscriptions and/or signups. For example, an online newspaper article may be blocked by a paywall, e.g., if a user clicks on the link without being a subscriber to the online newspaper. Access to a video, shared via a link in a social media post, may be blocked as premium content only viewable by subscribers.

In one approach, a user who is blocked from viewing a link to shared content can separately (and manually) search for similar content on a search engine, using, for example, the title and any preview information visible on the linked post. However, this approach is deficient because separate searches for content on search engines lead web traffic away from the social networking platform and create an unnecessary number of extra searches on search engines. In another approach, every time a user is blocked from viewing a link to shared content, the system can use web crawling to source alternatives to the shared content. However, this approach is deficient because sourcing alternative content every time the shared content is inaccessible to a user is inefficient and requires unnecessary server load.

To overcome these problems, systems and methods are provided herein for techniques for sharing alternative link posts by automatically verifying the accessibility by a target user to the content of a share link and sourcing alternative content when inaccessibility is detected. Specifically, when inaccessibility is detected, alternative posts and content are sourced. The system then presents one or more alternative link posts to the user. There can be various formats in presenting the alternative link posts, as well as the content of the original link post and its associated comments. The system also has the capability to remind posting users, at the point of sharing, that the link to be shared is behind a paywall and may not be accessible by some of the recipients. Upon providing this reminder, the system also provides alternative options for the posting user to choose from, some of which do not require a subscription for access or can be accessed by all or most of the posting user's target consumer audience. The posting user can then determine whether to take the suggestions and post the one or more alternative options or post their originally intended content.

In some embodiments, the system accesses a link post on a social networking service, the link post comprising a link to access shared content via a network. In some embodiments, the system determines that a device associated with a user account has limited access to the shared content. In some implementations, based at least in part on determining that the device associated with the user account has limited access to the shared content, the system identifies alternative content and provides the alternative content for consumption via the device associated with the user account.

Such aspects reduce or eliminate the consuming user's efforts in clicking on, verifying, and searching for alterative content. This approach improves user experiences in content sharing by eliminating the friction that article inaccessibility causes.

In some embodiments, the alternative content is one or more alternative articles that the system has determined the user account of the consuming user does not have limited access to. In some implementations, the alternative articles are selected by the user account of the posting user, either as an individual replacement article or as a subset of articles from options presented by the system. In some examples, the alternative articles are automatically selected by the social networking service.

In some embodiments, the alternative content is the same article as the shared content in a different format, containing the textual, image and video elements, as well as embedded links that were included in the shared content, for example, a portable document format (PDF) of one or more pages of the shared content, a series of images or screen captures of the shared content, a word processing document with the text and media of the shared content, or a slideshow with the text and media of the shared content. In some embodiments, the alternative content is a summary or an artificial intelligence (AI)-generated summary of the shared content. In some embodiments, the alternative content is a text-to-voice model-generated audio file comprising the shared content.

Such aspects reduce or eliminate the consuming user's efforts in clicking on, verifying, and searching for alterative content. This approach improves user experiences in content sharing by eliminating the friction that article inaccessibility causes.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIG. 1 shows illustrative examples of user notification and presentation of alternative link posts, in accordance with some embodiments of the present disclosure;

FIG. 2 is an illustrative example of a link post being locked and inaccessible without a subscription, with options to subscribe or generate alternative articles, in accordance with some embodiments of the present disclosure;

FIG. 3 is an illustrative example of alternative articles for a locked link post, in accordance with some embodiments of the present disclosure;

FIG. 4 is an illustrative example of a link post preview, with options to select alternative articles to present with the link post, in accordance with some embodiments of the present disclosure;

FIG. 5 is a flowchart of an illustrative process of a user sharing a link post, in accordance with some embodiments of the present disclosure;

FIG. 6 is a flowchart of an illustrative process of a user accessing a link post, in accordance with some embodiments of the present disclosure;

FIG. 7 is a flowchart of an illustrative process for sharing content through links via social media networks, in accordance with some embodiments of the present disclosure;

FIG. 8 is a block diagram of an illustrative media device, in accordance with some embodiments of this disclosure;

FIG. 9 is a diagram of an illustrative streaming system, in accordance with some embodiments of this disclosure;

FIG. 10 is a flowchart of an illustrative process for automated paywall detection from a browser, in accordance with some embodiments of the present disclosure;

FIG. 11 is a flowchart of an illustrative process for identifying alternative content, in accordance with some embodiments of the present disclosure;

FIG. 12 is a flowchart of an illustrative process for identifying alternative content, in accordance with some embodiments of the present disclosure;

FIG. 13 is a flowchart of an illustrative process for identifying alternative content, in accordance with some embodiments of the present disclosure;

FIG. 14 is a flowchart of an illustrative process for determining content subscription requirements, in accordance with some embodiments of the present disclosure; and

FIG. 15 is a flowchart of an illustrative process for determining content subscription requirements, in accordance with some embodiments of the present disclosure.

### DETAILED DESCRIPTION OF EMBODIMENTS OF THE DISCLOSURE

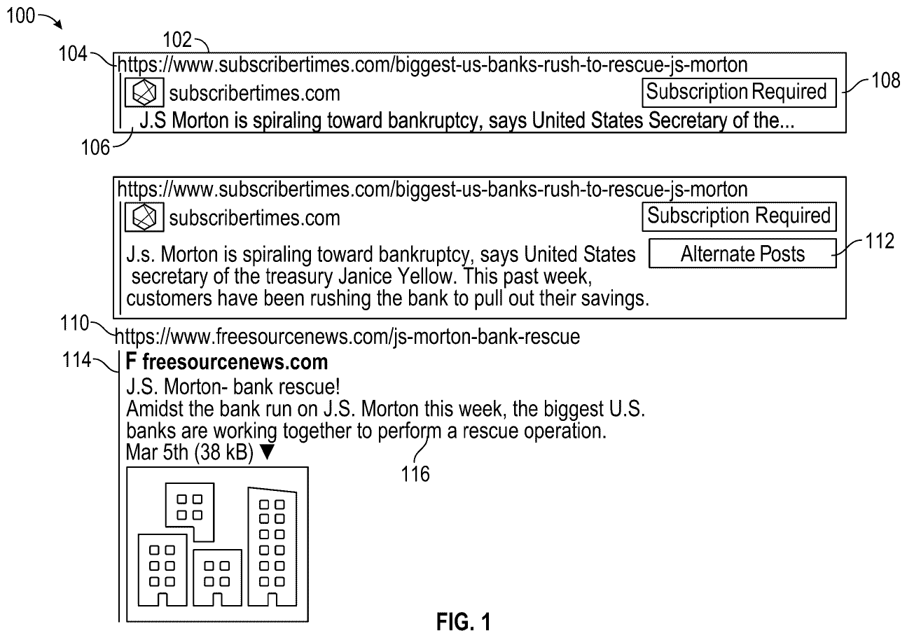

FIG. 1 shows illustrative examples of user notification and presentation of alternative link posts, in accordance with some embodiments of the present disclosure. In some embodiments, system 100 includes link post 102, link 104, link description 106, subscription requirement indicator 108, alternative article link 110, alternative posts user interface option 112, alternative article link post 114, and alternative article link description 116.

In some embodiments, a device associated with a user account is attempting to access already-posted link post 102 on, e.g., a social media network. In some embodiments, a device associated with a user account is generating link post 102 in preparation for posting link post 102 on, e.g., a social media network. For example, link post 102 depicts a post with a link to an article about a bank, “J. S. Morton,” that may be posted on a social media platform, e.g., Facebook, Instagram, or X (formerly known as Twitter). In some examples, a user in the poster's network sees link post 102, clicks on it, and discovers they do not have access to the article. As depicted in the bottom of FIG. 1, in some embodiments, a link post to an article behind a paywall might trigger grayed-out coloring over the text of link 104 and link description 106 and subscription requirement indicator 108 with the text “Subscription Required” to indicate that link 104 of link post 102 is inaccessible without a subscription.

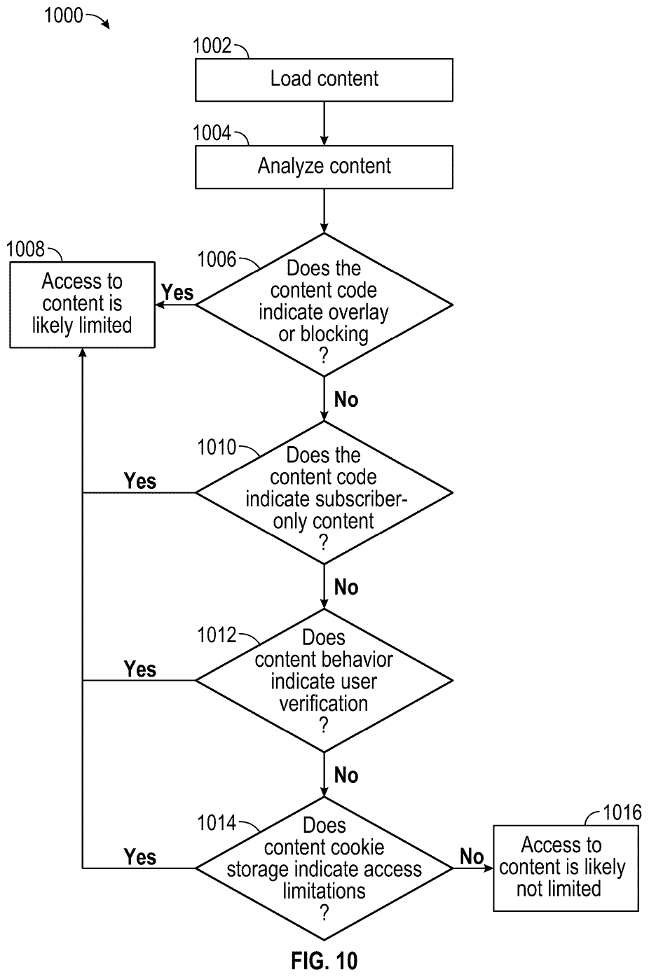

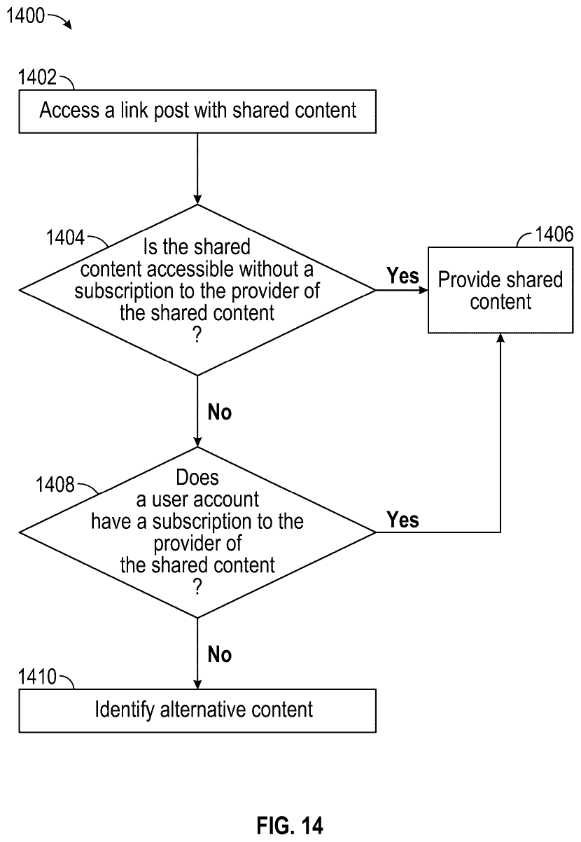

In some embodiments, the system determines that link post 102 is inaccessible without a subscription by determining the subscription requirements of the content and devices that may be attempting to access the content, as described further below with reference to FIG. 14. In some embodiments, the system determines that link post 102 is inaccessible without a subscription using automated paywall detection, as described further below with reference to FIG. 10.

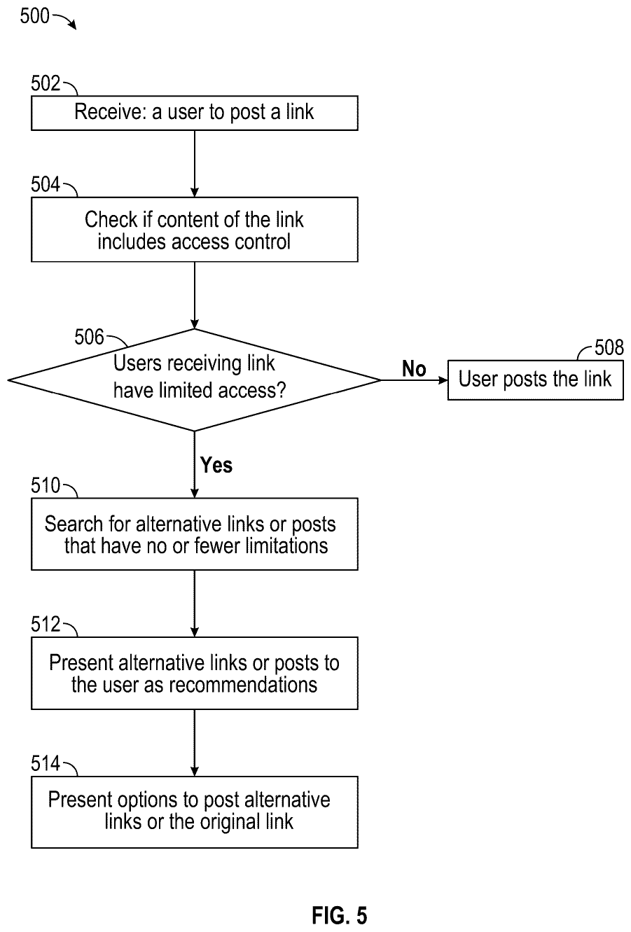

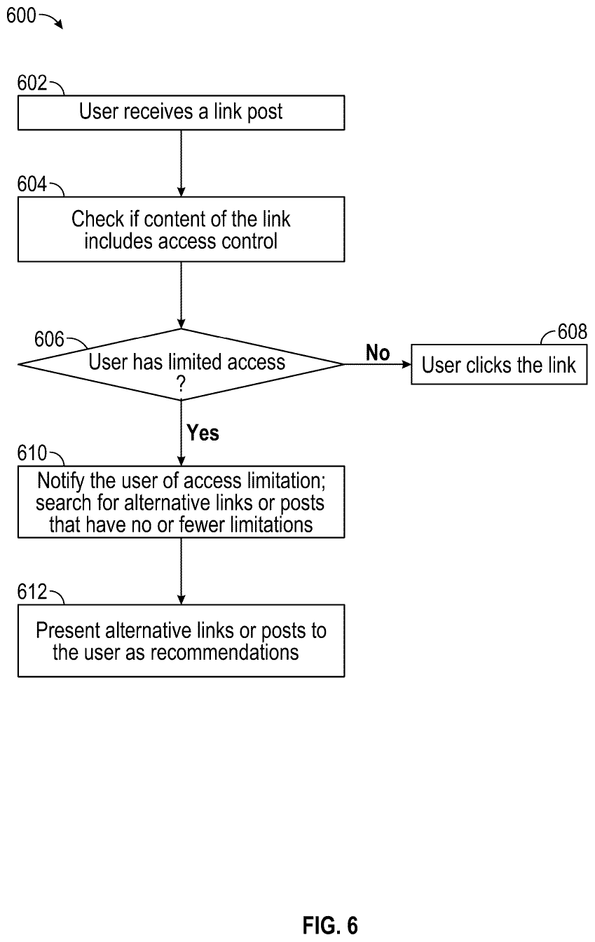

In some embodiments, the system populates alternative article link post 114 with alternative article link 110 and alternative article link description 116 within, below, or directly adjacent to link post 102. In some embodiments, the system populates alternative article link post 114 through a click-button pop-up, in a thread of the link post 102, or in a comment of link post 102. In some embodiments, the system populates alternative article link post 114 in response to receiving a user selection of alternative posts user interface option 112 from a device associated with a user account preparing to post link post 102, as described further below with reference to FIG. 5. In some embodiments, the system populates alternative article link post 114 in response to receiving a user selection of alternative posts user interface option 112 from a device associated with a user account attempting to access link post 102, as described further below with reference to FIG. 6.

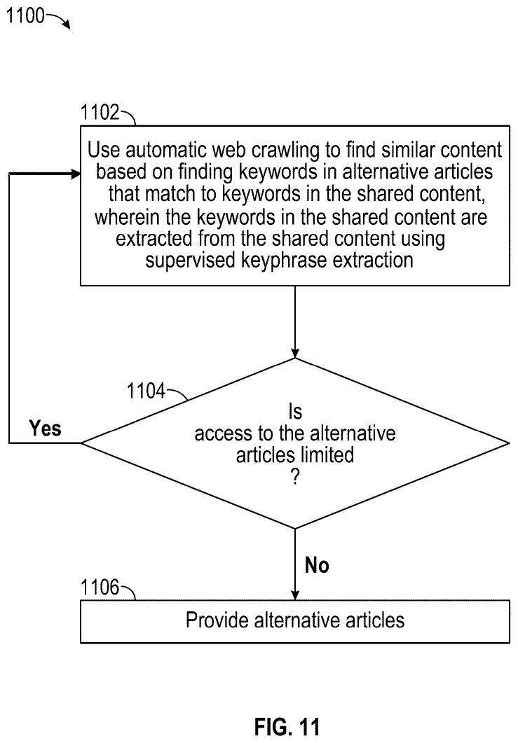

In some embodiments, the system automatically populates alternative posts user interface option 112 as an indicator that alternative article link post 114 has automatically been populated. In some embodiments, the system finds alternative article link 110 using automatic web crawling, as described further below with reference to FIGS. 11, 12, 13, and 15. In some embodiments, the browser on the device associated with the user account attempting to post link post 102 checks the access availability of the shared content and provides alternative links using automatic web crawling, as described further below with reference to FIGS. 11, 12, 13, and 15.

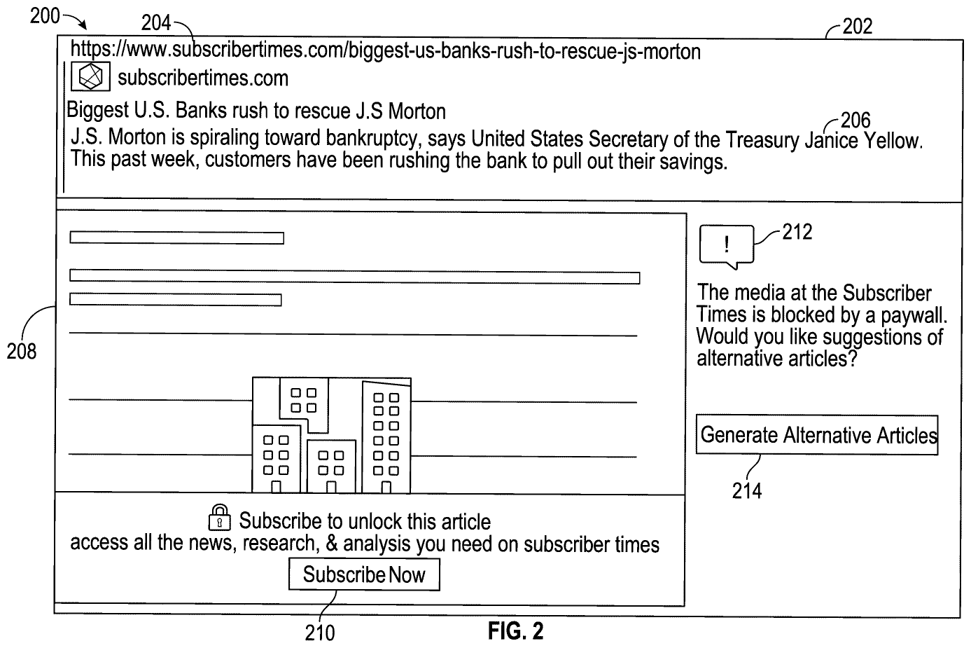

FIG. 2 is an illustrative example of a link post being locked and inaccessible without a subscription with options to subscribe or generate alternative articles, in accordance with some embodiments of the present disclosure. In some embodiments, system 200 includes link post 202, link 204, link description 206, link post preview 208, subscription user interface option 210, paywall alert 212, and alternative article generation user interface option 214.

In some embodiments, a device associated with a user account is attempting to access already-posted link post 202 on, e.g., a social media network. In some embodiments, link post preview 208 has grayed-out coloring, blurred text, and subscription user interface option 210 with the text “Subscribe Now” to indicate that link 204 of link post 202 is inaccessible without a subscription. In some embodiments, the system determines that link 204 is inaccessible without a subscription by determining the subscription requirements of the content and devices that may be attempting to access the content, as described further below with reference to FIG. 14. In some embodiments, the system determines that link 204 is inaccessible without a subscription using automated paywall detection, as described further below with reference to FIG. 10.

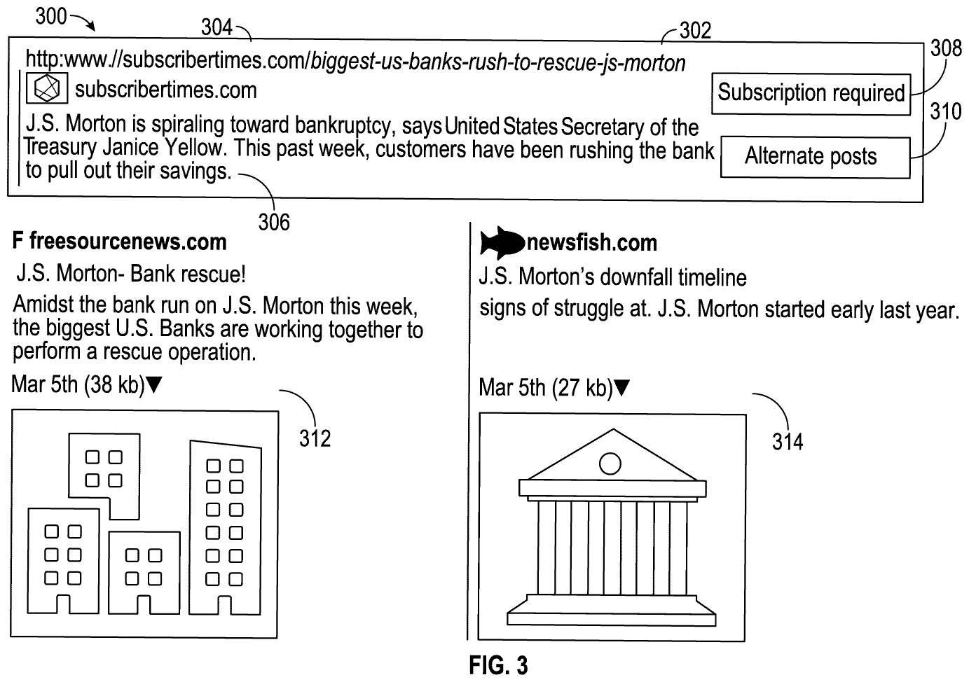

In some embodiments, in response to determining that link 204 is inaccessible without a subscription, the system generates paywall alert 212 with text indicating that the media at link 204 is blocked by a paywall, and alternative article generation user interface option 214 with text “Generate Alternative Articles.” In some embodiments, in response to receiving a user selection of alternative article generation user interface option 214, the system generates one or more alternative posts for the user, as described further above with reference to FIG. 1 and as described further below with reference to FIGS. 3 and 6. In some embodiments, a free trial for one or more or the original content and/or alternative content may be offered as part of the sharing process. For instance, an alternate article may be identified, and the alternative article may typically be behind a paywall but there may be an incentive to include the alternative article in a link post (e.g., as an alternative) by offering free access to connections who see the link post. There may be options for a trial period of time, limited number of articles, and/or a limited number of users who click the link post and/or alternative content. In some embodiments, after receiving a user selection of subscription user interface option 210, the system loads a webpage with user interface options to enter credentials and payment information to subscribe to the provider of the content at link 204 and, once credentials and payment information are entered, the system automatically loads the content at link 204.

FIG. 3 is an illustrative example of alternative articles for a locked link post, in accordance with some embodiments of the present disclosure. In some embodiments, system 300 includes link post 302, link 304, link description 306, subscription requirement indicator 308, alternative posts user interface option 310, first alternative post 312, and second alternative post 314.

In some embodiments, a device associated with a user account is attempting to access already-posted link post 302 on, e.g., a social media network. In some embodiments, link post 302 has grayed-out coloring over the text of link 304 and link description 306 and subscription requirement indicator 308 with the text “subscription required” to indicate that link 304 of link post 302 is inaccessible without a subscription. In some embodiments, the system determines that link 304 is inaccessible without a subscription by determining the subscription requirements of the content and devices that may be attempting to access the content, as described further below with reference to FIG. 14. In some embodiments, the system determines that link 304 is inaccessible without a subscription using automated paywall detection, as described further below with reference to FIG. 10.

In some embodiments, the system populates first alternative post 312 and second alternative post 314 within, below, or directly adjacent to link post 302. In some embodiments, the system populates first alternative post 312 and second alternative post 314 through a click-button pop-up, in a thread of the link post 102, or in a comment of link post 302. In some embodiments, the system populates first alternative post 312 and second alternative post 314 in response to receiving a user selection of alternative posts user interface option 310 from a device associated with a user account preparing to post link post 102, as described further below with reference to FIG. 5. In some embodiments, the system populates first alternative post 312 and second alternative post 314 in response to receiving a user selection of alternative posts user interface option 310 from a device associated with a user account attempting to access link post 302, as described further below with reference to FIG. 6.

In some embodiments, the system automatically populates alternative posts user interface option 310 as an indicator that first alternative post 312 and second alternative post 314 have automatically been populated. In some embodiments, the system finds articles for first alternative post 312 and second alternative post 314 using automatic web crawling, as described further below with reference to FIGS. 11, 12, 13, and 15. In some embodiments, the browser on the device associated with the user account attempting to post link post 102 checks the access availability of the shared content and provides alternative links using automatic web crawling, as described further below with reference to FIGS. 11, 12, 13, and 15.

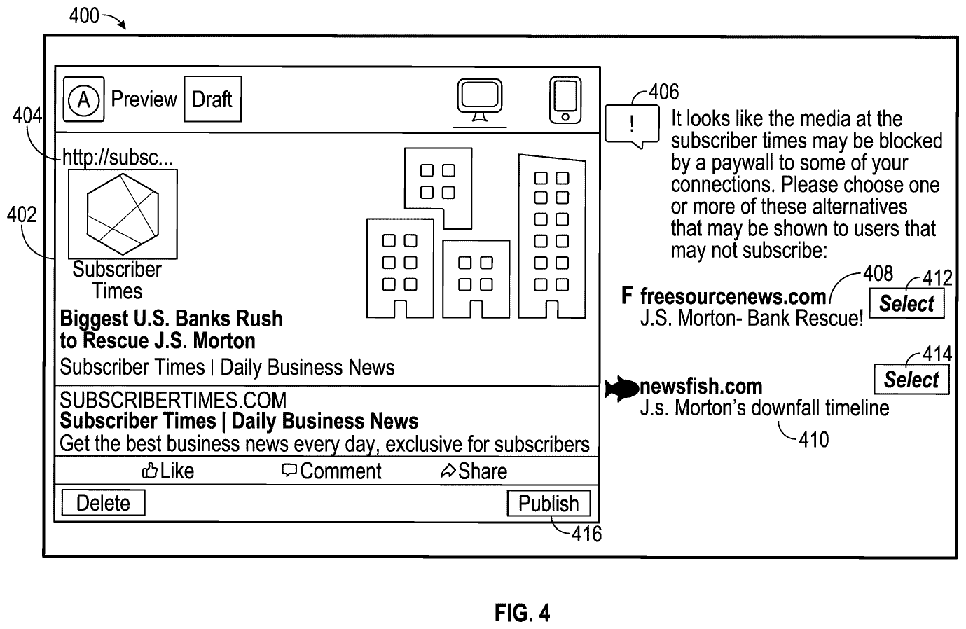

FIG. 4 is an illustrative example of a link post preview with options to select alternative articles to present with the link post, in accordance with some embodiments of the present disclosure. System 400 includes link post 402, link preview 404, paywall alert 406, first alternative post description 408, second alternative post description 410, first alternative post selection user interface option 412, second alternative post selection user interface option 414, and link post publish user interface option 416. In some embodiments, a device associated with a user account is generating link post 402 in preparation for posting link post 402 on, e.g., a social media network. In some embodiments, the system determines that the link previewed in link preview 404 is inaccessible without a subscription by determining the subscription requirements of the content and devices that may be attempting to access the content, as described further below with reference to FIG. 14. In some embodiments, the system determines that the link previewed in link preview 404 is inaccessible without a subscription using automated paywall detection, as described further below with reference to FIG. 10. In some embodiments, in response to determining that the link previewed in link preview 404 is inaccessible without a subscription, the system generates paywall alert 406 with text indicating that the media at the link previewed in link preview 404 is blocked by a paywall, and first alternative post description 408, second alternative post description 410, first alternative post selection user interface option 412, and second alternative post selection user interface option 414.

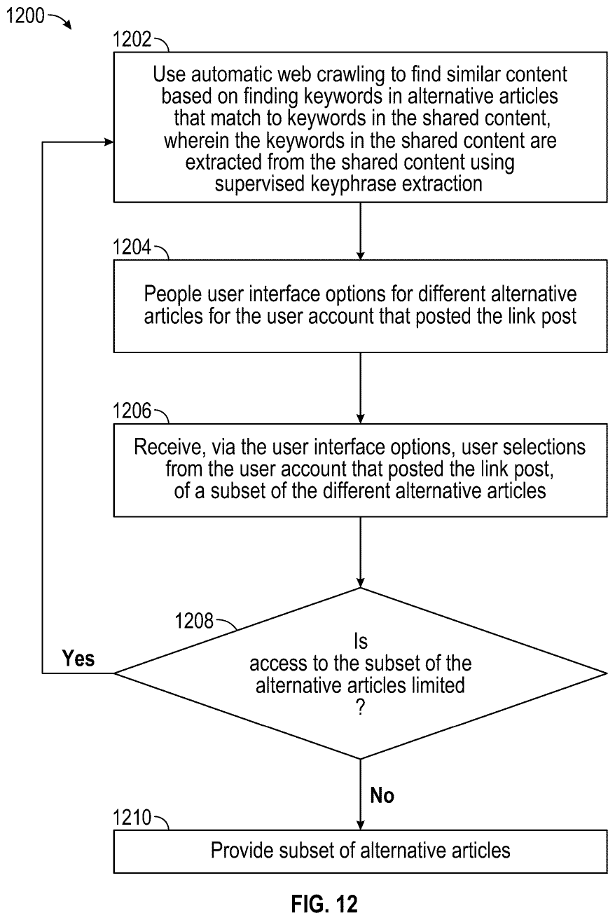

In some embodiments, the system identifies the articles described in first alternative post description 408 and second alternative post description 410 using automatic web crawling, as described further below with reference to FIGS. 11, 12, 13, and 15. In some embodiments, the browser on the device associated with the user account attempting to post link post 102 checks the access availability of the shared content and provides alternative links using automatic web crawling, as described further below with reference to FIGS. 11, 12, 13, and 15. In some embodiments, the system populates first alternative post selection user interface option 412 and second alternative post selection user interface option 414 and receives user selections from the device associated with the user account generating link post 402 of one or more of first alternative post selection user interface option 412 and second alternative post selection user interface option 414 as a subset of alternative articles to post, as described further below with reference to FIG. 12. In some embodiments, the system receives a user selection of link post publish user interface option 416 to publish link post 402, whether or not alternative articles have been selected.

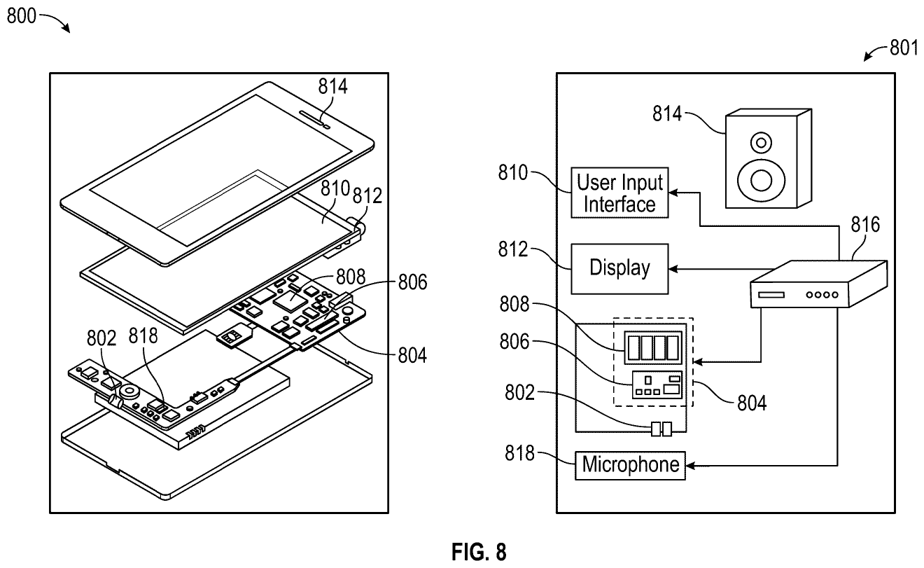

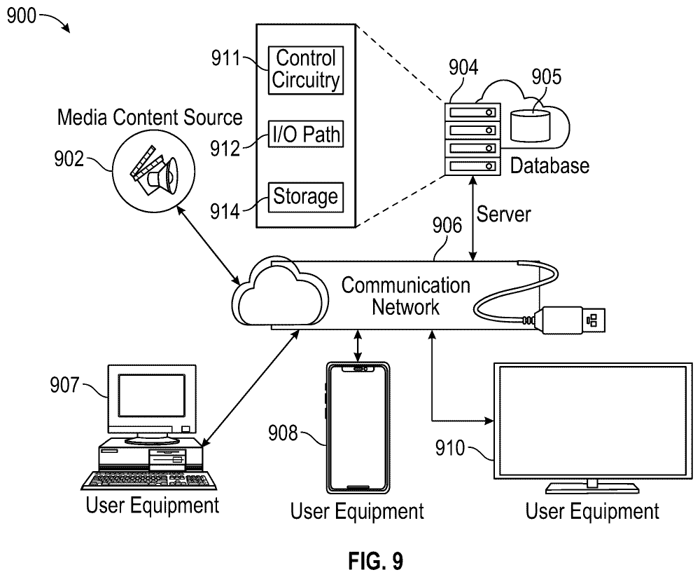

FIG. 5 is a flowchart of an illustrative process of a user sharing a link post, in accordance with some embodiments of the present disclosure. In some embodiments, the steps outlined in process 500 are performed by one or more servers and devices of FIGS. 8 and 9. For example, non-transitory memories of one or more components of the server and devices of FIGS. 8 and 9, e.g., storage 914 and control circuitry 911, may store instructions that, when executed, e.g., by the server and devices of FIGS. 8 and 9 (as described further below with reference to FIGS. 8 and 9) cause execution of the process depicted in FIG. 5. The actions and descriptions of FIG. 5 may be used with any other embodiment of this disclosure. In addition, the actions and descriptions described in FIG. 5 may be done in suitable alternative orders or in parallel to further the purposes of this disclosure.

In some embodiments, at 502, control circuitry, for example, control circuitry 911 of FIG. 9, receives actions from a user preparing to post a link, e.g., link 104 of FIG. 1, on, for example, a social media network. At 504, the control circuitry checks if the content of the link includes access control, as described further below with reference to FIG. 10. At 506, the control circuitry determines whether the link has limited access, for example, for a group of users that may consume the post, as described further below with reference to FIG. 10. In some embodiments, if the link does not have limited access, process 500 proceeds to 508. In some embodiments, if the link does have limited access, process 500 proceeds to 510.

At 508, the control circuitry indicates that the user can freely post the link. At 510, the control circuitry searches for alternative links of posts that have no or fewer limitations, as described further below with reference to FIGS. 11 through 13 and 15. In some embodiments, at 512, the control circuitry presents alternative links or posts to the user device of the user who is preparing to post the link as recommendations. In some embodiments, the alternative links are alternative articles, as described further above with reference to FIG. 4. In some embodiments, the alternative posts are one or more of a portable document format (PDF) of one or more pages of the shared content, a series of images of the shared content, a word processing document of the shared content, a slideshow of the linked article comprising the textual, image and video elements, or embedded links that are included in the linked article, an excerpt, a summary or an artificial intelligence (AI) generated summary of the shared content, or a text-to-voice model generated audio file comprising the shared content. At 514, the control presents options to post alternative links or the original link, as described further above with reference to FIG. 4.

FIG. 6 is a flowchart of an illustrative process of a user accessing a link post, in accordance with some embodiments of the present disclosure. In some embodiments, the steps outlined in process 600 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 6. The actions and descriptions of FIG. 6 may be used with any other embodiment of this disclosure. In addition, the actions and descriptions described in FIG. 6 may be done in suitable alternative orders or in parallel to further the purposes of this disclosure.

In some embodiments, at 602, control circuitry, for example, control circuitry 911 of FIG. 9, receives a link post at a device of a user account accessing, for example, a social media network. At 604, control circuitry checks if content of the link includes access control, as described further below with reference to FIG. 10. At 606, the control circuitry determines whether the link has limited access for the user account attempting to access the post, as described further below with reference to FIG. 10. In some embodiments, if the link does not have limited access, process 600 proceeds to 608. In some embodiments, if the link does have limited access, process 600 proceeds to 610.

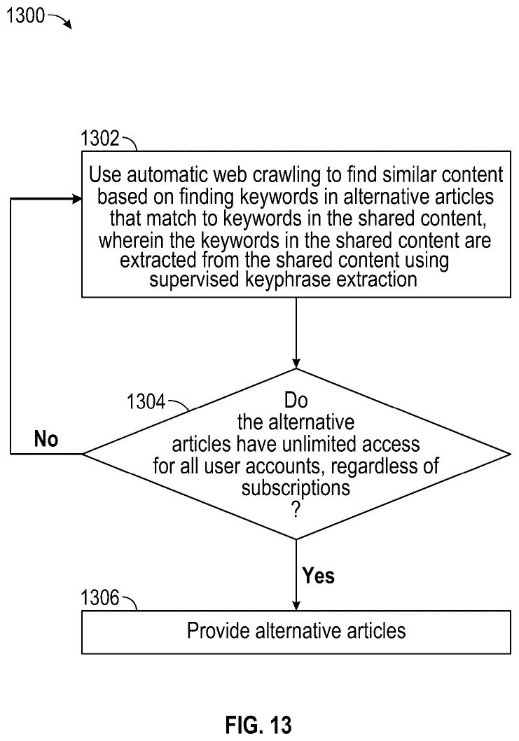

At 608, the control circuitry indicates that the user account is freely able to click on and access the link. At 610, the control circuitry notifies the device of the user account of the access limitation and searches for alternative links or posts that have no or less limitation, as described further below with reference to FIGS. 11 and 13. At 612, the control circuitry presents alternative links or posts to the device of the user account as recommendations.

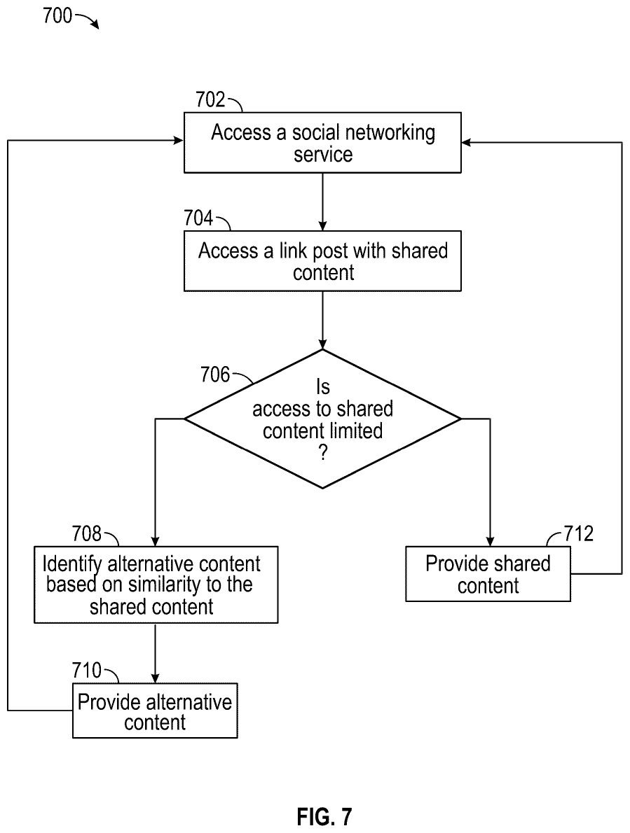

FIG. 7 is a flowchart of an illustrative process for sharing content through links via social media networks, in accordance with some embodiments of the present disclosure. In some embodiments, the steps outlined in process 700 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 7. The actions and descriptions of FIG. 7 may be used with any other embodiment of this disclosure. In addition, the actions and descriptions described in FIG. 7 may be done in suitable alternative orders or in parallel to further the purposes of this disclosure.

In some embodiments, at 702, control circuitry, for example, control circuitry 911 of FIG. 9, accesses a social networking service. At 704, the control circuitry accesses a link post with shared content, for example, link post 102 of FIG. 1. At 706, the control circuitry determines whether access to the shared content is limited, as described further below with reference to FIG. 10. In some embodiments, if the access to the shared content is not limited, process 700 proceeds to 712. In some embodiments, if the access to the shared content is limited, process 700 proceeds to 708.

At 712, the control circuitry provides the original shared content, for example, posts the original shared content on the social networking service. At 708, the control circuitry identifies alternative content. In some embodiments, the alternative content is alternative articles, as described further above with reference to FIGS. 4, 11-13, and 15. In some embodiments, the alternative posts are one or more of a portable document format (PDF) of one or more pages of the shared content, a series of images of the shared content, a word processing document of the shared content, a slideshow of the linked article comprising the textual, image and video elements, or embedded links that are included in the linked article, a summary or an artificial intelligence (AI)-generated summary of the shared content, or a text-to-voice model-generated audio file comprising the shared content. At 710, the control circuitry provides the alternative content, for example, posts the alternative content on the social networking service. In some embodiments, the alternative content is posted alongside a preview of the original content on a link post, as described further above with reference to FIGS. 1 and 3.

FIGS. 8 and 9 describe exemplary devices, systems, servers, and related hardware for sharing content through links via social media networks, in accordance with some embodiments of the present disclosure. FIG. 8 shows generalized embodiments of illustrative devices 800 and 801. For example, devices 800 and 801 may be smartphone devices, laptops, televisions smart televisions, streaming sticks, smart speakers, or voice assistants. Device 801 may include set-top box 816. Set-top box 816 may be communicatively connected to microphone 818, speaker 814, and display 812. In some embodiments, microphone 818 may receive voice commands. In some embodiments, display 812 may be a television display or a computer display. In some embodiments, set-top box 816 may be communicatively connected to user input interface 810. In some embodiments, user input interface 810 may be a remote-control device. Set-top box 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive content and data via input/output (“I/O”) path 802. I/O path 802 may provide content (e.g., broadcast programming, on-demand programming, internet content, content available over a local area network (LAN) or wide area network (WAN), and/or other content) and data to control circuitry 804, which includes processing circuitry 806 and storage 608. Control circuitry 804 may be used to send and receive commands, requests, and other suitable data using I/O path 802, which may comprise I/O circuitry. I/O path 802 may connect control circuitry 804 (and specifically processing circuitry 606) to one or more communications paths (described below). I/O functions may be provided by one or more of these communications paths but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a media application stored in memory (i.e., storage 808). Specifically, control circuitry 804 may be instructed by the media application to perform the functions discussed above and below. In some implementations, any action performed by control circuitry 804 may be based on instructions received from the media application.

In client/server-based embodiments, control circuitry 804 may include communications circuitry suitable for communicating with a media application server or other networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media application data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry, such as one or more analog tuners, one or more MPEG-4 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The tuning and encoding circuitry may be used by device 800, 801 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from device 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of device 800 and device 601. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The media application may be implemented using any suitable architecture. For example, it may be a stand-alone application wholly implemented on each one of device 800 and device 801. In such an approach, instructions of the application are stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to rearrange the segments as discussed. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the media application is a client/server-based application. Data for use by a thick or thin client implemented on each one of device 800 and device 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the application in a storage device. The remote server may process the stored instructions using circuitry (e.g., control circuitry 804) to perform the operations discussed in connection with FIGS. 1-7 and 10-17.

In some embodiments, the media application may be downloaded and interpreted or otherwise run by an interpreter or virtual machine (run by control circuitry 804). In some embodiments, the media application may be encoded in the ETV Binary Interchange Format (EBIF), received by the control circuitry 804 as part of a suitable feed, and interpreted by a user agent running on control circuitry 804. For example, the media application may be an EBIF application. In some embodiments, the media application may be defined by a series of JAVA-based files that are received and run by a local virtual machine or other suitable middleware executed by control circuitry 804. In some of such embodiments (e.g., those employing MPEG-2 or other digital media encoding schemes), the media application may be, for example, encoded and transmitted in an MPEG-2 object carousel with the MPEG audio and video packets of a program.

FIG. 9 is a diagram of an illustrative streaming system, in accordance with some embodiments of the disclosure. Devices 907, 908, 910 may be coupled to communication network 906. Communication network 906 may be one or more networks including the internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some examples, the processes outlined within system 900 are performed by the MGA of FIG. 1. In some embodiments, server 904 may include control circuitry 911 and a storage 914 (e.g., RAM, ROM, Hard Disk, Removable Disk, etc.). In some embodiments, storage 914 may store instructions that when, executed by control circuitry 911, may cause execution of the MGA, for example, by causing the MGA to execute the steps outlined within system 900. Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 911 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve guidance data from media content source 902, process the data as will be described in detail below, and forward the data to devices 907 and 910. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an internet provider of content of broadcast programs for downloading, etc.). Media content source 902 may include cable sources, satellite providers, on-demand providers, internet providers, over-the-top content providers, or other providers of content. Media content source 902 may also include a remote media server used to store different types of content (including video content selected by a user), in a location remote from any of the client devices. Media content source 902 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 904), which may be located centrally or at distributed locations, that provide cloud-based services to various types of users and devices connected via a network such as the internet via communication network 906. In such embodiments, devices may operate in a peer-to-peer manner without communicating with a central server.

FIG. 10 is a flowchart of an illustrative process for automated paywall detection from a browser, in accordance with some embodiments of the present disclosure. In some embodiments, the steps outlined in process 1000 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 10. The actions and descriptions of FIG. 10 may be used with any other embodiment of this disclosure. In addition, the actions and descriptions described in FIG. 10 may be done in suitable alternative orders or in parallel to further the purposes of this disclosure.

In some embodiments, at 1002, control circuitry, for example, control circuitry 911 of FIG. 9, loads content. For example, the control circuitry automatically loads the webpage that the link of a link post, e.g., link post 102 of FIG. 1, leads to. In some embodiments, the control circuitry uses a headless browser or a web scraping tool that can fetch and render the page content similarly to how a real browser would render the page content. At 1004, the control circuitry analyzes the content, e.g., the page structure of the webpage. For example, once the page is loaded, the control circuitry inspects the HTML structure for elements commonly associated with paywalls. In some embodiments, the elements have specific class names or IDs such as paywall, subscription, premium content, or metered content. In some implementations, these tags denote content that is restricted or hidden behind a paywall. At 1006, the control circuitry determines whether the content code indicates overlay or blocking, for example, the control circuitry looks for overlay elements that block access to the main content. In some implementations, the overlays prompt users to log in or subscribe to view the full content. In some examples, the overlays have styles, e.g., “display: block” or “visibility: visible” that indicate they are active and covering the content. In some embodiments, if the content code indicates overlay or blocking, process 1000 proceeds to 1008. In some embodiments, if the content code does not indicate overlay or blocking, process 1000 proceeds to 1010.

At 1008, the control circuitry determines that access to the content is likely limited. At 1010, the control circuitry determines whether the content code indicates subscriber-only content, for example, by analyzing the text of the webpage. In some embodiments, the control circuitry extracts the text content of the webpage and searches for common phrases that indicate a paywall, for example, “subscribe to read more,” “log in to access,” “membership required,” “premium content,” “please sign in,” and “to continue reading.” In some embodiments, the control circuitry analyzes if the main content text is hidden or obscured by CSS properties like “display: none,” “opacity: 0,” or “visibility: hidden,” which indicates, in some cases, that the content is being withheld until the user performs a certain action, such as logging in or subscribing. In some embodiments, if the content code indicates subscriber-only content, process 1000 returns to 1008. In some embodiments, if the content code does not indicate subscriber-only content, process 1000 proceeds to 1012.

At 1012, the control circuitry determines whether content behavior indicates user verification. In some embodiments, the control circuitry automatically observes network requests made by the webpage. In some examples, paywalled content involves additional requests to verify user subscription status or to fetch content dynamically based on user credentials, and the control circuitry analyzes those requests to see if they are returning paywall-related responses or errors for non-subscribers. In some examples, paywalls redirect users to a login or subscription page if they try to access restricted content. In some embodiments, the control circuitry monitors for any such redirections that occur after the initial page load. In some embodiments, if the content behavior indicates user verification, process 1000 returns to 1008. In some embodiments, if the content behavior does not indicate user verification, process 1000 proceeds to 1014.

At 1014, the control circuitry determines whether content cookie storage indicates access limitations. In some embodiments, the control circuitry analyzes the cookies set by the webpage. In some examples, websites use cookies to manage user sessions and track whether a user has access to the content. In some implementations, cookies might be set or updated when a user encounters a paywall. In some embodiments, the control circuitry checks for the presence of items in local storage or session storage that might indicate a paywall. In some examples, websites use these storage mechanisms to store information about user access and paywall status. In some embodiments, if the content cookie storage indicates access limitations, process 1000 returns to 1008. In some embodiments, if the content cookie storage does not indicate access limitations, process 1000 proceeds to 1016. At 1016, the control circuitry determines that access to content is likely not limited. In some embodiments, some social media apps may allow displaying link post content within the app, e.g., not automatically switching to a browser upon a user's click on the link within the link post. In such examples, the restriction on access will be assessed accordingly using similar steps as process 1000.

FIG. 11 is a flowchart of an illustrative process for identifying alternative content, in accordance with some embodiments of the present disclosure. In some embodiments, the steps outlined in process 1100 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 11. The actions and descriptions of FIG. 11 may be used with any other embodiment of this disclosure. In addition, the actions and descriptions described in FIG. 11 may be done in suitable alternative orders or in parallel to further the purposes of this disclosure.

In some embodiments, step 1102 is executed following the determination that access to shared content is limited at process step 706 of FIG. 7, as described further above with reference to FIG. 7. In some embodiments, at 1102, control circuitry, for example, control circuitry 911 of FIG. 9, uses automatic web crawling to find similar content based on finding keywords in alternative articles that match to keywords in the shared content, wherein the keywords in the shared content are extracted from the shared content using supervised keyphrase extraction. In some embodiments, at 1104, the control circuitry determines whether access to the alternative articles is limited, for example, using the automated paywall detection processes described above with reference to FIG. 10. In some embodiments, if access to the alternative articles is limited, process 1100 returns to 1102. In some embodiments, if access to the alternative articles is not limited, process 1100 proceeds to 1106.

In some embodiments, at 1106, the control circuitry provides the alternative articles, e.g., for consumption at a device associated with the user account attempting to access a link post with limited access content or for a device attempting to post a link post with limited access content. In some embodiments, following step 1106, process 1100 continues to step 702 of FIG. 7, as described further above with reference to FIG. 7.

FIG. 12 is a flowchart of an illustrative process for identifying alternative content, in accordance with some embodiments of the present disclosure. In some embodiments, the steps outlined in process 1200 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 12. The actions and descriptions of FIG. 12 may be used with any other embodiment of this disclosure. In addition, the actions and descriptions described in FIG. 12 may be done in suitable alternative orders or in parallel to further the purposes of this disclosure.

In some embodiments, step 1202 is executed following the determination that access to shared content is limited at process step 706 of FIG. 7, as described further above with reference to FIG. 7. At 1202, control circuitry, for example, control circuitry 911 of FIG. 9, uses automatic web crawling to find similar content based on finding keywords in alternative articles that match to keywords in the shared content, wherein the keywords in the shared content are extracted from the shared content using supervised keyphrase extraction. At step 1204, the control circuitry populates user interface options for different alternative articles for the user account that posted the link post. At step 1206, the control circuitry receives, via the user interface options, user selections from the user account that posted the link post, of a subset of the different alternative articles. At step 1208, the control circuitry determines whether access to the subset of alternative articles is limited, for example, using the automated paywall detection processes described above with reference to FIG. 10. In some embodiments, if access to the subset of alternative articles is limited, process 1200 returns to 1202. In some embodiments, if access to the subset of alternative articles is not limited, process 1200 proceeds to 1210.

At step 1210, the control circuitry provides the subset of alternative articles, e.g., for consumption at a device associated with the user account attempting to access a link post with limited access content or for a device attempting to post a link post with limited access content. In some embodiments, following step 1210, process 1200 continues to step 702 of FIG. 7, as described further above with reference to FIG. 7.

FIG. 13 is a flowchart of an illustrative process for identifying alternative content, in accordance with some embodiments of the present disclosure. In some embodiments, the steps outlined in process 1300 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 13. The actions and descriptions of FIG. 13 may be used with any other embodiment of this disclosure. In addition, the actions and descriptions described in FIG. 13 may be done in suitable alternative orders or in parallel to further the purposes of this disclosure.

In some embodiments, step 1302 is executed following the determination that access to shared content is limited at process step 706 of FIG. 7, as described further above with reference to FIG. 7. At 1302, control circuitry, for example, control circuitry 911 of FIG. 9, uses automatic web crawling to find similar content based on finding keywords in alternative articles that match to keywords in the shared content, wherein the keywords in the shared content are extracted from the shared content using supervised keyphrase extraction. At 1304, the control circuitry determines whether the alternative articles can be accessed by any user. In some embodiments, if the alternative articles cannot be accessed by any user, process 1300 returns to 1302. In some embodiments, if the alternative articles can be accessed by any user, process 1300 proceeds to 1306.

At 1306, the control circuitry provides the alternative articles, e.g., for consumption at a device associated with the user account attempting to access a link post with limited access content or for a device attempting to post a link post with limited access content. In some embodiments, following step 1306, process 1300 continues to step 702 of FIG. 7, as described further above with reference to FIG. 7.

FIG. 14 is a flowchart of an illustrative process for determining content subscription requirements, in accordance with some embodiments of the present disclosure. In some embodiments, the steps outlined in process 1400 are performed by one or more servers and devices of FIGS. 8 and 9. For example, non-transitory memories of one or more components of the server and devices of FIGS. 8 and 9, e.g., storage 914 and control circuitry 911, may store instructions that, when executed e.g., by the server and devices of FIGS. 8 and 9 (as described further below with reference to FIGS. 8 and 9) cause execution of the process depicted in FIG. 14. The actions and descriptions of FIG. 14 may be used with any other embodiment of this disclosure. In addition, the actions and descriptions described in FIG. 14 may be done in suitable alternative orders or in parallel to further the purposes of this disclosure.

In some embodiments, step 1402 is executed following step 704 of FIG. 7, as described further above with reference to FIG. 7. In some embodiments, at 1402, control circuitry, for example, control circuitry 911 of FIG. 9, accesses a link post with shared content. At 1404, the control circuitry determines whether the shared content is accessible without a subscription to the provider of the shared content, e.g., the journal, newspaper, or online magazine that originally published the shared content. In some embodiments, if the shared content is accessible without a subscription to the provider of the shared content, process 1400 proceeds to 1406. In some embodiments, if the shared content is not accessible without a subscription to the provider of the shared content, process 1400 proceeds to 1408.

At 1406, the control circuitry provides the shared content, e.g., for consumption at a device associated with the user account attempting to access a link post with limited access content or for a device attempting to post a link post with limited access content. In some embodiments, following step 1406, process 1400 continues to step 702 of FIG. 7, as described further above with reference to FIG. 7. At 1408, the control circuitry determines whether the user account associated with the device attempting to access the shared content has a subscription to the provider of the shared content. In some embodiments, if the user account has a subscription to the provider of the shared content, process 1400 continues to 1406. In some embodiments, if the user account does not have a subscription to the provider of the shared content, process 1400 proceeds to 1410.

At 1410, the control circuitry identifies alternative content, for example, using processes described above with reference to FIGS. 11, 12, 13, and 15. In some embodiments, the browser on the device associated with the user account attempting to post link post 102 checks the access availability of the shared content and provides alternative links using automatic web crawling, as described further above with reference to FIGS. 11, 12, 13, and 15. In some embodiments, following step 1410, process 1400 continues to step 710 of FIG. 7, as described further above with reference to FIG. 7.

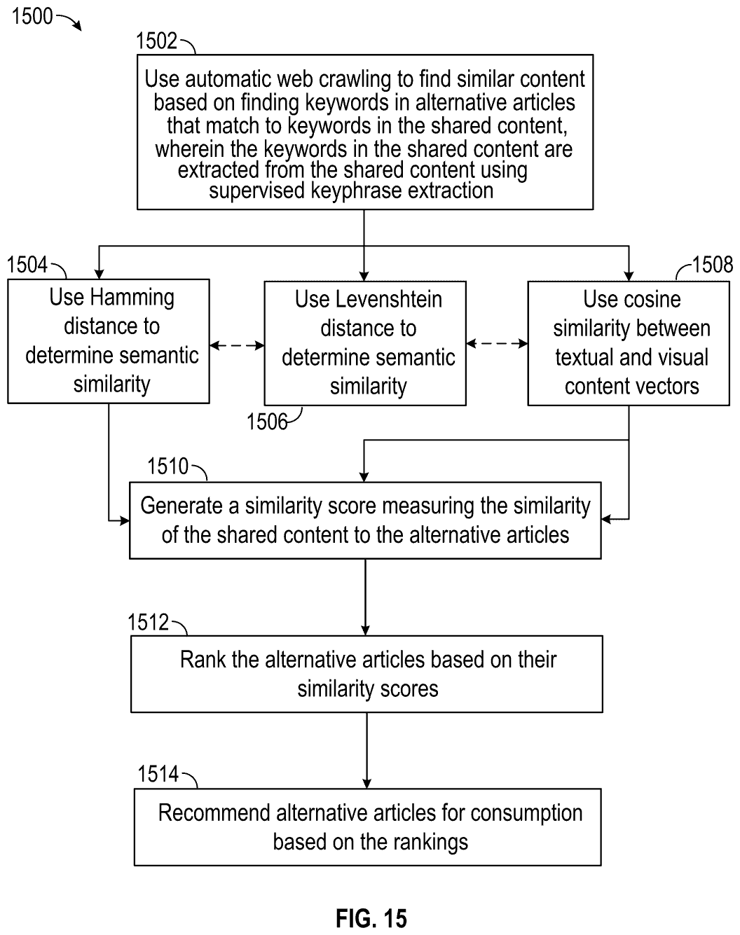

FIG. 15 is a flowchart of an illustrative process for determining content subscription requirements, in accordance with some embodiments of the present disclosure. In some embodiments, the steps outlined in process 1500 are performed by one or more servers and devices of FIGS. 8 and 9. For example, non-transitory memories of one or more components of the server and devices of FIGS. 8 and 9, e.g., storage 914 and control circuitry 911, may store instructions that, when executed, e.g., by the server and devices of FIGS. 8 and 9 (as described further below with reference to FIGS. 8 and 9) cause execution of the process depicted in FIG. 15. The actions and descriptions of FIG. 15 may be used with any other embodiment of this disclosure. In addition, the actions and descriptions described in FIG. 15 may be done in suitable alternative orders or in parallel to further the purposes of this disclosure.

In some embodiments, step 1502 is executed, e.g., following the determination that access to shared content is limited at process step 706 of FIG. 7, as described further above with reference to FIG. 7. At 1502, the control circuitry, for example, control circuitry 911 of FIG. 9, uses automatic web crawling to find similar content based on finding keywords in alternative articles that match to keywords in the shared content, wherein the keywords in the shared content are extracted from the shared content using supervised keyphrase extraction. In some embodiments, control circuitry executes at least one of process steps 1504, 1506, and 1508 prior to proceeding to process step 1510. In some embodiments, the control circuitry executes two or more of process steps 1504, 1506, and 1508 simultaneously prior to proceeding to process step 1510. At 1504, the control circuitry uses Hamming distance to determine semantic similarity between the shared content and alternative articles. At 1506, the control circuitry uses Levenshtien distance to determine semantic similarity between the shared content and alternative articles. At 1508, the control circuitry uses cosine similarity between textual and visual content vectors of the shared content and the alternative articles to determine similarity. At 1510, the control circuitry generates a similarity score measuring the similarity of the shared content to the alternative articles, using one or more of the Hamming distance measurement, Levenshtien distance measurement, and the cosine similarity measurement from process steps 1504, 1506, and 1508, respectively. At 1512, the control circuitry ranks the alternative articles based on their similarity scores. At 1514, the control circuitry recommends alternative articles for consumption based on the rankings. In some embodiments, following step 1514, process 1500 continues to step 702 of FIG. 7, e.g., as described further above with reference to FIG. 7.

The foregoing is merely illustrative of the principles of this disclosure and its various embodiments. Various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
accessing a link post on a social networking service, the link post comprising a link to access shared content via a network;
determining that a device associated with a user account has limited access to the shared content;
based at least in part on determining that the device associated with the user account has limited access to the shared content, identifying alternative content, wherein the alternative content is identified based on similarity to the shared content;
determining that the user account does not have limited access to the alternative content; and
providing the alternative content for consumption via the device associated with the user account.

2. The method of claim 1, wherein the identifying the alternative content comprises:
identifying one or more alternative articles; and
determining that the one or more alternative articles can be accessed by any user.

3. The method of claim 1, wherein the identifying the alternative content comprises:
identifying one or more alternative articles; and
wherein the one or more alternative articles are identified at least in part based on a selection of a plurality of alternative articles by a user account that posted the link post.

4. The method of claim 3, further comprising:
receiving, at a device associated with the user account that posted the link post, a notification that the link may not be accessible by some of the recipients.

5. The method of claim 3, wherein the selection of the plurality of alternative articles by the user account that posted the link post comprises receiving the selection of the plurality of alternative articles as a subset of a plurality of options of alternative articles.

6. The method of claim 1, wherein the identifying the alternative content based on similarity to the shared content comprises:
identifying one or more alternative articles; and
wherein the one or more alternative articles are identified automatically by the social networking service, wherein the automatically identifying the one or more alternative articles comprises automatic web crawling for similar content based on finding keywords in alternative articles that match to keywords in the shared content, wherein the keywords in the shared content are extracted from the shared content using supervised keyphrase extraction.

7. The method of claim 6, further comprising:
generating a similarity score measuring the similarity of the shared content to the each article of the one or more alternative articles by using a model to measure one or more selected from the following: Hamming distance or Levenshtein distance to determine semantic similarity, and cosine similarity between textual and visual content vectors.

8. The method of claim 7, further comprising:
ranking the one or more alternative articles based at least in part on their similarity scores; and
recommending one or more articles of the one or more alternative articles for consumption based on the rankings.

9. The method of claim 1, wherein the determining that the device associated with the user account has limited access to the shared content comprises:
determining that the shared content is not accessible without a subscription to the provider of the shared content; and
determining that the user account does not have a subscription to the provider.

10. The method of claim 1, wherein the alternative content comprises one or more of a portable document format (PDF) of one or more pages of the shared content, a series of images of the shared content, a word processing document of the shared content, a slideshow of the linked article comprising the textual, image and video elements, or embedded links that are included in the linked article, an artificial intelligence (AI)-generated summary of the shared content, or a text-to-voice model-generated audio file comprising the shared content.

11. A system comprising:
control circuitry configured to:
access a link post on a social networking service, the link post comprising a link to access shared content via a network;
determine that a device associated with a user account has limited access to the shared content;
based at least in part on determining that the device associated with the user account has limited access to the shared content, identify alternative content, wherein the alternative content is identified based on similarity to the shared content;
determine that the user account does not have limited access to the alternative content; and
provide the alternative content for consumption via the device associated with the user account.

12. The system of claim 11, wherein the control circuitry is further configured to identify the alternative content by:
identifying one or more alternative articles; and
determining that the one or more alternative articles can be accessed by any user.

13. The system of claim 11, wherein the control circuitry is further configured to identify the alternative content by:
identifying one or more alternative articles; and
wherein the one or more alternative articles are identified at least in part based on a selection of a plurality of alternative articles by a user account that posted the link post.

14. The system of claim 13, wherein the control circuitry is further configured to:
receive, at a device associated with the user account that posted the link post, a notification that the link may not be accessible by some of the recipients.

15. The system of claim 13, wherein the control circuitry, with the selection of the plurality of alternative articles by the user account that posted the link post is configured to receive the selection of the plurality of alternative articles as a subset of a plurality of options of alternative articles.

16. The system of claim 11, wherein the control circuitry is configured to identify the alternative content based on similarity to the shared content by:
identifying one or more alternative articles; and
wherein the one or more alternative articles are identified automatically by the social networking service, wherein the automatically identifying the one or more alternative articles comprises automatic web crawling for similar content based on finding keywords in alternative articles that match to keywords in the shared content, wherein the keywords in the shared content are extracted from the shared content using supervised keyphrase extraction.

17. The system of claim 16, wherein the control circuitry is further configured to:
generate a similarity score measuring the similarity of the shared content to the each article of the one or more alternative articles by using a model to measure one or more selected from the following: Hamming distance or Levenshtein distance to determine semantic similarity, and cosine similarity between textual and visual content vectors.

18. The system of claim 17, wherein the control circuitry is further configured to:
rank the one or more alternative articles based at least in part on their similarity scores; and
recommend one or more articles of the one or more alternative articles for consumption based on the rankings.

19. The system of claim 11, wherein the control circuitry is configured to determine that the device associated with the user account has limited access to the shared content by:
determining that the shared content is not accessible without a subscription to the provider of the shared content; and
determining that the user account does not have a subscription to the provider.

20. The system of claim 11, wherein the alternative content comprises one or more of a portable document format (PDF) of one or more pages of the shared content, a series of images of the shared content, a word processing document of the shared content, a slideshow of the linked article comprising the textual, image and video elements, or embedded links that are included in the linked article, an artificial intelligence (AI)-generated summary of the shared content, or a text-to-voice model-generated audio file comprising the shared content.

21-50. (canceled)
